(19) United States
(12) Patent Application Publication
(10) Pub. No.: US 2026/0095929 A1
(43) Pub. Date: Apr. 2, 2026

(54) METHODS AND APPARATUES FOR READER-TO-DEVICE/DEVICE-TO-READER (R2D/D2R) TRANSMISSION

(71) Applicant: InterDigital Patent Holdings, Inc., Wilmington, DE (US)

(72) Inventors: Kevin WANUGA, Conshohocken, PA (US); Erdem BALA, East Meadow, NY (US); Martino FREDA, Laval (CA); Paul MARINIER, Brossard (CA); Aata EL HAMSS, LAVAL (CA); Remun KOIRALA, London (GB); Moon IL LEE, Melville, NY (US)

(73) Assignee: InterDigital Patent Holdings, Inc., Wilmington, DE (US)

(21) Appl. No.: 18/902,426

(22) Filed: Sep. 30, 2024

(51) Int. Cl. H04W 72/51; H04W 72/40

(52) U.S. Cl. CPC H04W 72/51; H04W 72/40

(57) ABSTRACT

Methods and apparatuses are described herein for reader-to-device/device-to-reader (R2D/D2R) transmissions. A wireless transmit/receive unit (WTRU) may be configured to transmit a message comprising at least one command to a set of devices. The WTRU may determine, based on data associated with the at least one command, that the at least one command cannot be completed by a device of the set of devices with a first set of resources. The at least one command is to be performed by at least the device of the set of devices. The WTRU may transmit, to the device, on a condition that the at least one command cannot be completed by the device with the first set of resources, a second set of resources to complete the at least one command.

### BACKGROUND

Reader-to-device (R2D) and device-to-reader (D2R) transmissions in the Internet of Things (IoT) describe the data exchange between a reader (e.g., an IoT gateway, RFID reader, or hub) and an IoT device (e.g., a sensor, RFID tag, or smart device). R2D transmission is initiated by the reader, typically to request data, wake up devices, or send commands. D2R transmission is initiated by the IoT device, typically to transmit data, respond to a query, or send alerts. However, current R2D/D2R transmission does not consider timing constraints and timing ambiguity created by IoT devices, for example, due to data processing/preparation, errors in reference timing frequencies, and available power on IoT devices.

### SUMMARY

Methods and apparatuses are described herein for reader-to-device (R2D) and device-to-reader (D2R) transmission. For example, a wireless transmit/receive unit (WTRU) may be configured to transmit, to a set of devices, a message comprising at least one command. The at least one command may comprise at least one of a write command or a read command. The WTRU may determine, based on data associated with the at least one command, that the at least one command cannot be completed by a device of the set of devices with a first set of resources. The at least one command may be performed by at least the device of the set of devices. The WTRU may transmit, to the device, on a condition that the at least one command cannot be completed by the device with the first set of resources, a second set of resources to complete the at least one command.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example inventory procedure;

FIG. 3 is a diagram illustrating an example topology;

FIG. 4 is a diagram illustrating another example topology;

FIG. 5A is a diagram illustrating another example topology;

FIG. 5B is a diagram illustrating another example topology;

FIG. 6 is a diagram illustrating another example topology;

FIG. 7 is a diagram illustrating an example random access procedure;

FIG. 8 is a diagram illustrating an example procedure for provisioning one or more resources;

FIG. 9 is a diagram illustrating an example signal flow;

FIG. 10 is a diagram illustrating an example procedure;

FIG. 11 is a diagram illustrating an example procedure for a contention-free resource indication;

FIG. 12 is a diagram illustrating an example procedure for an indication of resources based on prioritized random-access;

FIG. 13 is a diagram illustrating an example of time windows between messages; and

FIG. 14 is a diagram illustrating another example of time windows between messages.

### DETAILED DESCRIPTION

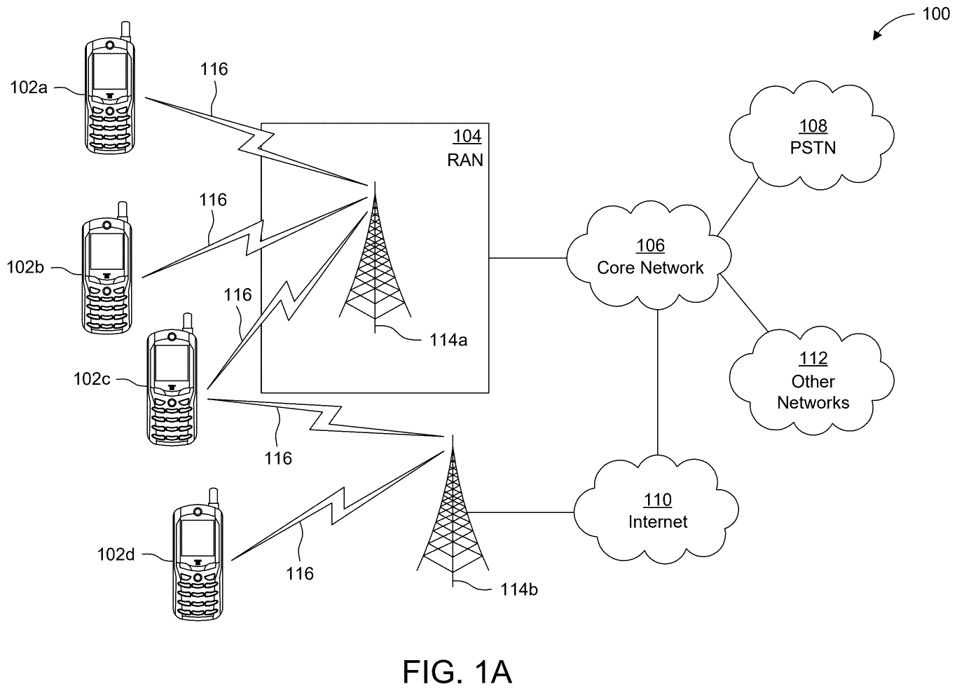

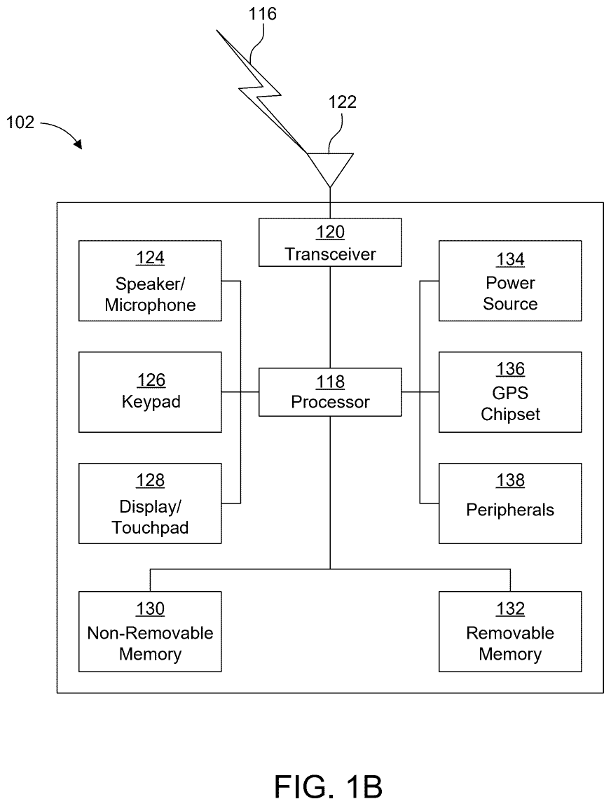

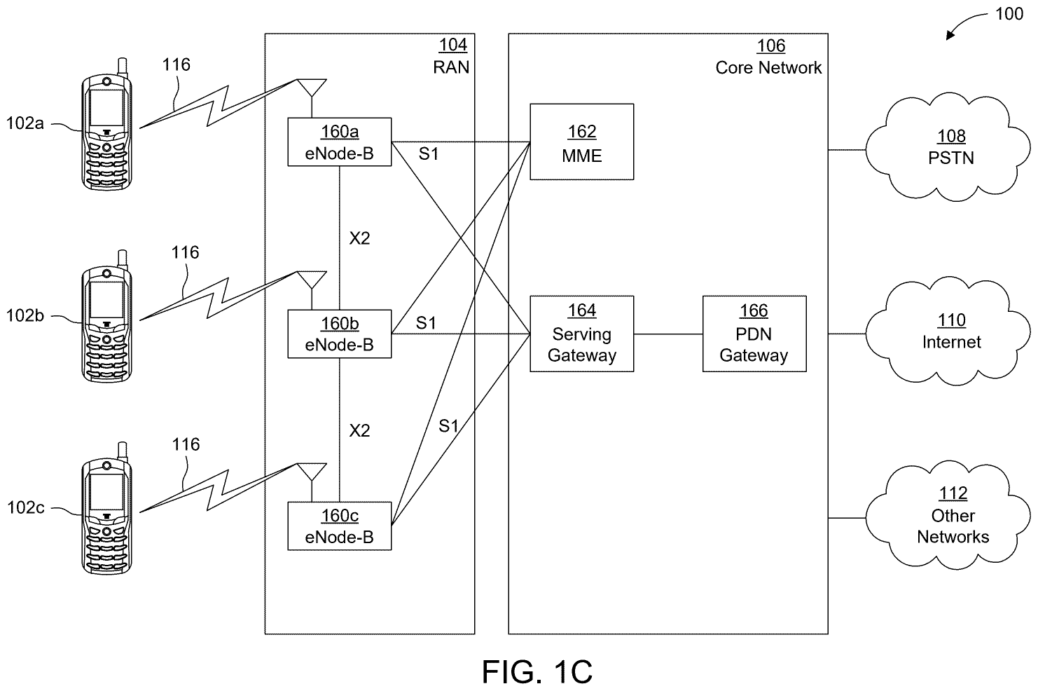

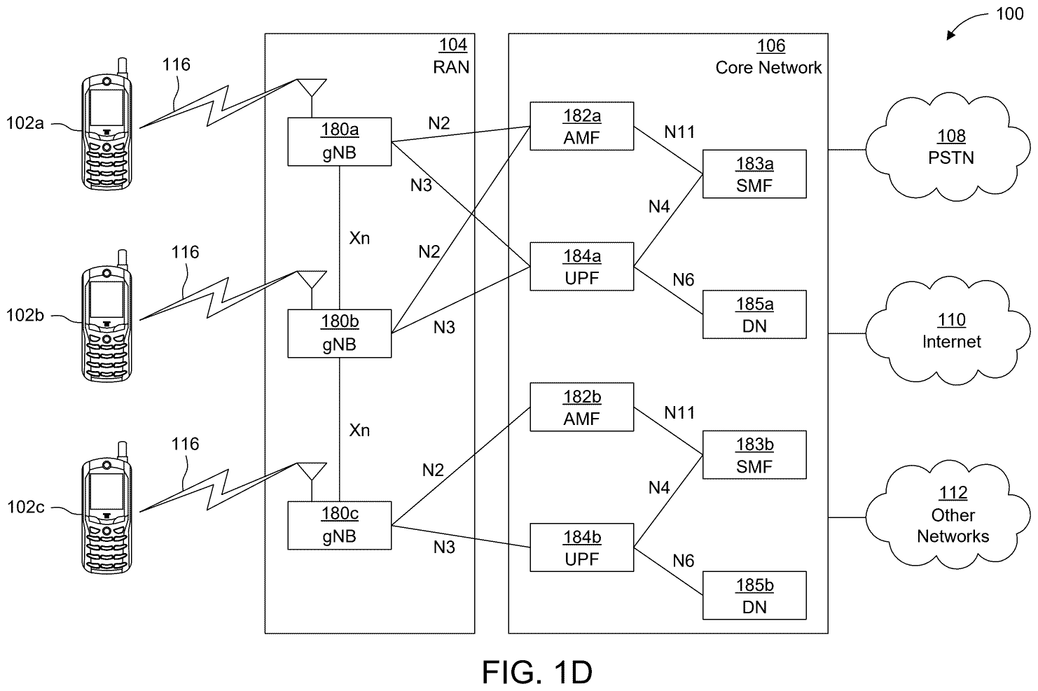

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a reader, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, a reader, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

Artificial Intelligence of Things (AIoT or A-IoT) is the integration of Artificial Intelligence (AI) with the Internet of Things (IoT). It combines the connectivity and data exchange capabilities of IoT devices with the decision-making and analytical power of AI. In the context of 3rd Generation Partnership Project (3GPP) and its work on Radio Access Networks (RAN), AIoT devices are IoT devices that integrate Artificial Intelligence (AI) capabilities into IoT systems to optimize data collection, processing, and decision-making. Device types that may be considered for support of A-IoT in 3GPP RAN may include, but are not limited to, device1 (or device type 1), device2 a (or device type 2a), and device2b (or device type 2b). For example, device1 may have its peak power consumption less than 1 μW (e.g., ˜1 μW). Device1 may have energy storage and initial sampling frequency offset (SFO) up to 10^{X} ppm. But device 1 may neither have DL nor UL amplification in the device. The device's UL transmission may be backscattered on a carrier wave provided externally.

Device2a may have its peak power consumption less than or equal to a few hundred μW (e.g., ≤a few hundred μW). Device2a may have energy storage and initial sampling frequency offset (SFO) up to 10^{X} ppm. Device2 may have both DL and/or UL amplification in the device. The device's UL transmission may be backscattered on a carrier wave provided externally.

Device2b may have its peak power consumption less than or equal to a few hundred μW (e.g., ≤a few hundred μW). Device2b may have energy storage and initial sampling frequency offset (SFO) up to 10^{X} ppm. Device2b may have both DL and/or UL amplification in the device. The device's UL transmission may be generated internally by the device.

Each of these devices may have significantly reduced processing and transmission capabilities. Device type 1 and device type 2a may not generate signals without energy provided by a carrier wave from the associated reader.

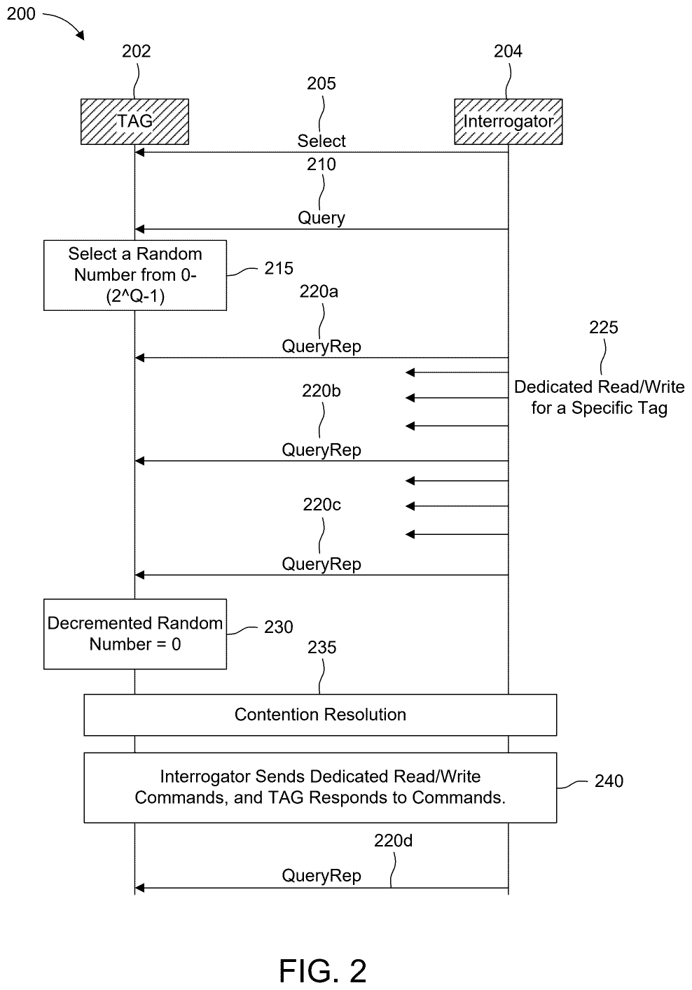

FIG. 2 illustrates an example inventory procedure 200, which may be used in combination with any of other embodiments described herein. The inventory procedure 200 may be used for RFID, which may be used for applications of asset identification. As illustrated in FIG. 2, an interrogator 204 (or a reader) may send a select message 205 to filter and choose which tags to interact with from a large group of tags. The select message 205 may set criteria or filters to reduce the number of tags that will respond to the interrogator 204. The interrogator 204 (or a reader) may send a query message 210 to energize all or a subset of tags. Following the query message 210, a tag 202 may select a random number from 0-2\hat{ }Q-1 at 215 and load its memory with that number. At each transmission of a QueryRep 220a-c, the tag 202 may decrement its counter until the counter reaches 0. Once the correct tag is selected, the interrogator 204 may issue a dedicated read or dedicated write command 225 to retrieve or update the data stored on the tag. When the counter reaches 0 at 230, the tag 202 may initiate a contention resolution procedure 235 which comprises transmitting its device ID in the uplink and waiting for confirmation of the device ID in the downlink (e.g., to address possible collision between multiple devices selecting the same random number). For a device that has passed contention resolution, the interrogator 204 may send multiple read/write commands at 240, to which the tag 202 may respond.

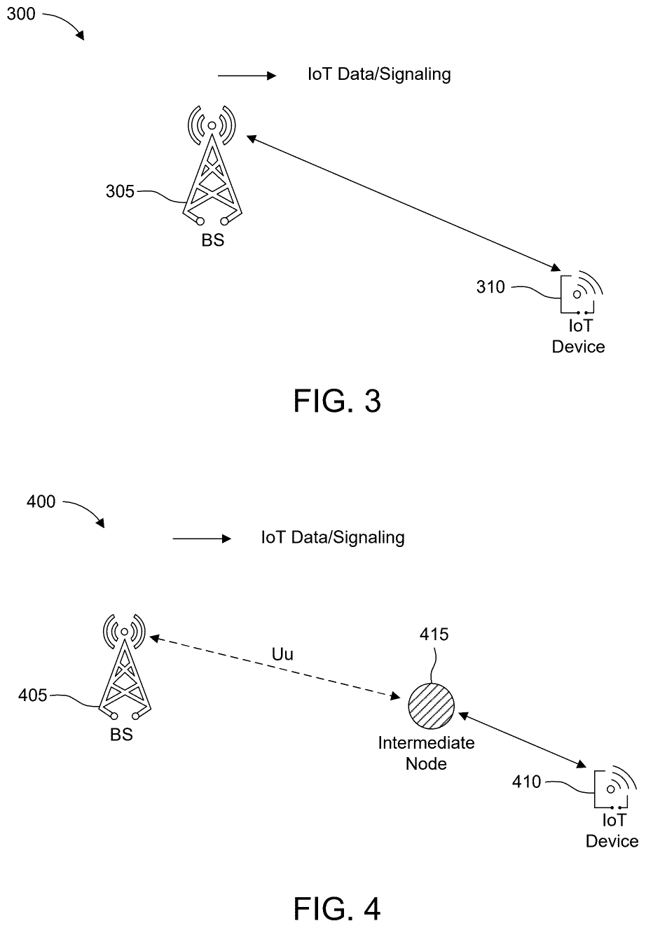

FIGS. 3-6 illustrates example topologies 300, 400, 500, 550, 600, which may be used in combination with any of other embodiments described herein. For example, example topologies 300, 400, 500, 550, 600 described in FIGS. 3-6 may be used for IoT and/or AIoT.

FIG. 3 illustrates an example topology 300, which may be used in combination with any of other embodiments described herein. As illustrated in FIG. 3, an IoT device 310 may directly and/or bidirectionally communicate with a base station (BS) 305. The IoT device 310 may be any type of IoT device. The type of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. The communication between the BS 305 and the IoT device 310 (e.g., ambient IoT device) may include IoT data and/or signaling (e.g., ambient IoT data and/or signaling). The topology 300 may include the possibility that the BS transmitting to the IoT device 310 is different from the BS receiving from the IoT device. In the topology 300, the BS 305 may be a reader, and the IoT device 310 may be a tag.

FIG. 4 illustrates an example topology 400, which may be used in combination with any of other embodiments described herein. As illustrated in FIG. 4, an IoT device 410 may communicate bidirectionally with an intermediate node 415 between the IoT device 410 and BS 405. The IoT device 410 may be any type of IoT device. The types of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. In the topology 400, the intermediate node 415 may be a relay, an integrated access and backhaul (IAB) node, WTRU, UE, a repeater, or the like, which is capable of IoT communication. The intermediate node may transfer the information between the BS 405 and the IoT device 410. In the topology 400, the BS 405 and/or the intermedia node 415 (e.g., a relay or a repeater) may be a reader, and the IoT device 410 may be a tag.

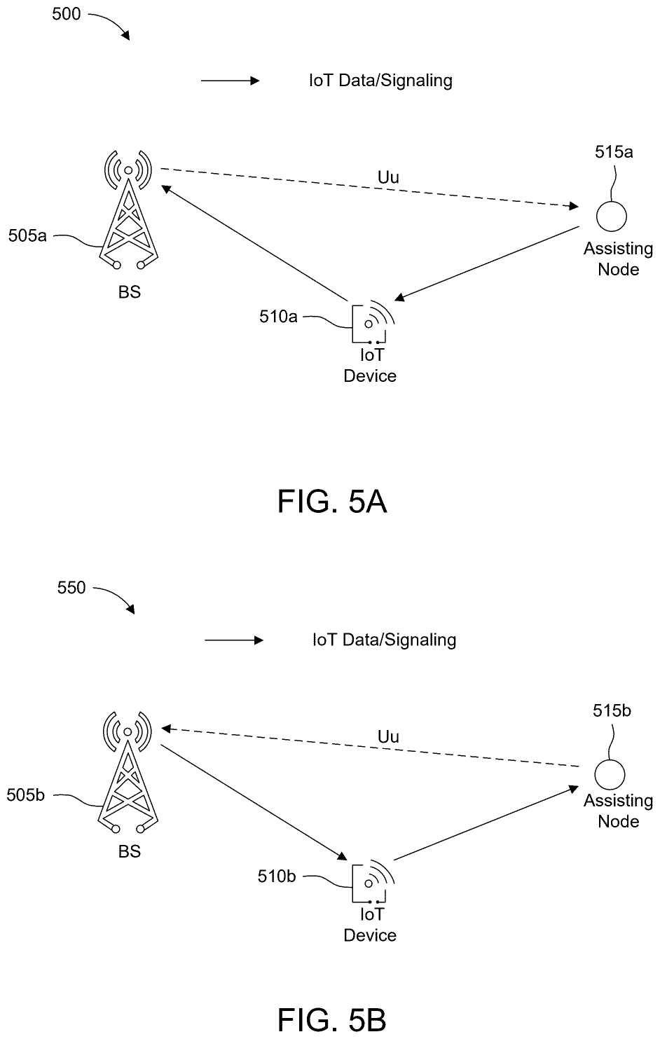

FIGS. 5A-B illustrate example topologies 500, 550, which may be used in combination with any of other embodiments described herein. As illustrated in FIG. 5A, an IoT device 510a may transmit data/signaling to a BS 505a and receive data/signaling from an assisting node 515a. As illustrated in FIG. 5B, an IoT device 510b may receive data/signaling from a BS 505b and transmit data/signaling to an assisting node 515b. The IoT devices 510a-b may be any type of IoT device. The types of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. In the topologies 500, 550, the assisting nodes 515a-b may be a relay, IAB, WTRU, UE, a repeater, or the like, which is capable of IoT communication. In the topologies 500, 550, the BS 505a-b and/or the assisting node 515a-b (e.g., a repeater or a relay) may be a reader, and the IoT device 510a-b may be a tag.

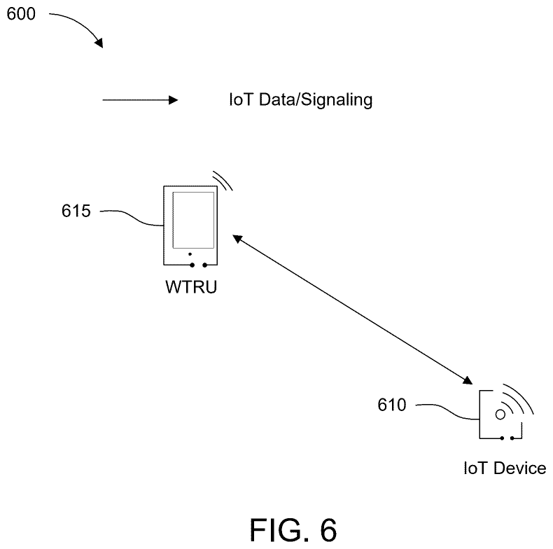

FIG. 6 illustrates an example topology 600, which may be used in combination with any of other embodiments described herein. As illustrated in FIG. 6, an IoT device 610 may communicate bidirectionally with a WTRU 615 (or UE). The IoT device 610 may be any type of IoT device. The type of IoT device may include, but are not limited to, an ambient IoT device, a wearable device, a smart home device, an industrial IoT device, a healthcare IoT device, an environmental monitoring device, a smart city device, a connected vehicle, an agricultural IoT device, a smart grid device, and a consumer IoT device. The communication between the WTRU 615 and the IoT device 610 may include IoT data and/or signaling (e.g., ambient IoT data and/or signaling). In the topology 600, the WTRU 615 (or UE) may be a reader, and the IoT device 610 may be a tag.

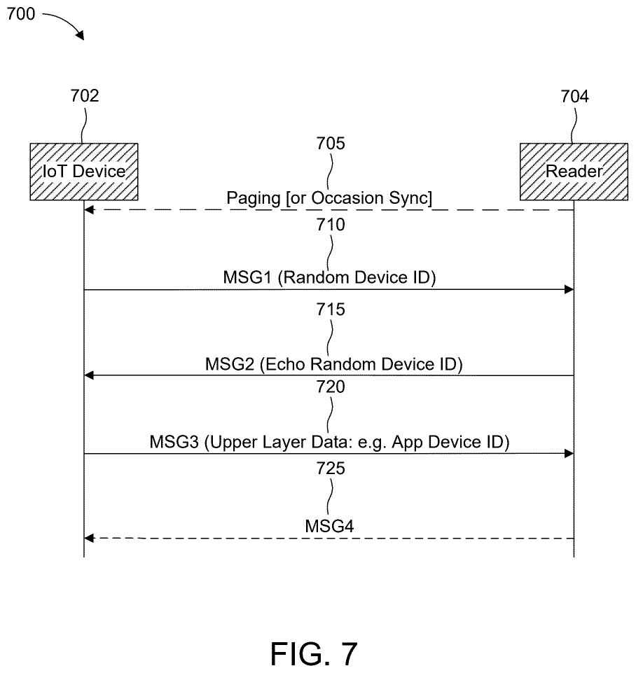

FIG. 7 illustrates an example IoT random access procedure 700, which may be used in combination with any of other embodiments described herein. The IoT random access procedure 700 may also be used for AIoT. For example, AIoT devices may perform the IoT random access procedure 700 with a reader 704. As illustrated in FIG. 7, the reader 704 may send a paging message 705 and a set of occasion synchronization messages which respectively provides the device IDs of the devices to responds and configures/delimits the random-access occasions for transmissions by the IoT devices. An IoT device 702 may select an occasion (e.g., using at least slotted ALOHA as the baseline), and transmit a random device ID in MSG1 710. The reader 704, upon successful reception of MSG1 710, may transmit MSG2 715 by including the received random device ID in MSG2 715. If the IoT device 702 receives the echoed random device ID in MSG2 715, it may transmit MSG3 720 which may include upper layer data (e.g., an application layer device ID). MSG4 725 may be transmitted by the reader 704 (e.g., for subsequent command transmission), but the contention may already be resolved at MSG2 transmission.

For D2R transmission following an R2D transmission, the D2R transmission timing may be determined or achieved by defining a time window in which D2R transmission is expected by the reader and/or the reader assigning a transmission occasion in a control message. For R2D transmission following a D2R transmission, the R2D transmission timing may be determined or achieved by defining a time window in which R2D transmission is performed by the reader and expected by the device. However, current R2D/D2R transmissions do not consider the timing constraints and/or timing ambiguity created by IoT devices, for example, due to data processing/preparation, errors in reference timing frequencies, and available power on IoT devices. Thus, methods and apparatuses for provisioning one more resources for the transmission of data to/from the reader/device accounting for the timing constraints and/or timing ambiguity are needed.

The terms device, IoT device, AIoT device, IoT UE, AIoT UE, IoT WTRU, AIoT WTRU, and tag may be used interchangeably throughout this disclosure to mean an IoT device that is being inventoried/queried by a reader.

The term reader may refer to the entity which queries the IoT device, either directly, or via an intermediate node (e.g., the intermediate node 415 in FIG. 4). The term reader may also refer to the intermediate node 415 in FIG. 4. As a result, the term reader may refer to a network node, a WTRU or a UE that queries the IoT device, depending on the context and/or the topology. For example, in FIG. 3, the BS 305 may be a reader that queries the IoT device.

The terms reader, network, network node, intermediate node, assisting node, intermediate UE, assisting UE, intermediate WTRU, and assisting WTRU may be used interchangeably throughout this disclosure. This may result in a tradeoff between number of resources for random access, the size of the random ID (i.e., the number of unique IDs that can be selected), and the power consumption associated with the IoT devices. Specifically, a large number of resources may not be preferable because it increases the time required for the inventory procedure. The time may be shortened using less resources and increasing the size of the random ID. However, this may result in increased power consumption. If the same size of the random ID is used in all cases, the system may consume the power of IoT device unnecessarily.

The term inventory procedure may refer to the overall procedure of a reader triggering access by multiple IoT devices using a sequence of messages (e.g., similar to query, followed by QueryRep 220a-d in FIG. 2). Specifically, the inventory procedure may refer to a single round of attempts to have each IoT device respond or attempt to respond with its access ID or perform a RACH procedure. Specifically, the inventory procedure may refer to a set of access occasions which may have 0 or at least 1 IoT device respond within the access occasion. The inventory procedure may occur similar to legacy RFID procedure. The term inventory procedure may be used interchangeably with a paging procedure, a query procedure, or the like depending on IoT device requirements and/or specifications.

The term occasion may refer to the opportunity for IoT device transmission that may be delimited by the transmission of a query rep message (or similar). Specifically, an IoT device may perform transmission in an occasion by performing an IoT transmission in a defined time following the QueryRep message associated with that transmission. Alternatively or additionally, an occasion may include both a time aspect and a frequency aspect. Specifically, an IoT device may determine an occasion as a transmission following a specific QueryRep message, and by transmitting on one of a number of frequencies (e.g., FDM). Throughout this disclosure, selection of an occasion may be applied equivalently to selection of only a time component and/or selection of a frequency component.

Throughout this disclosure, any reference to time may be associated with an absolute time measurement (e.g., seconds, slots, frames, etc.). Alternatively or additionally, it may refer to a number of executions of a procedure, possibly triggered by a reader (e.g., number of inventory procedures, number of accesses or RACH procedures, etc.). Alternatively or additionally, it may refer to a number of messages, for example, of a specific type, or including specific information received or transmitted.

Configuration or pre-configuration may refer to any configuration received by a message or prestored in an IoT device or a network node. Examples of the message may include, but are not limited to, an RRC message, a MAC CE, a PHY layer signal, a data PDU, and a control PDU associated with any or a new protocol layer. These messages may be received from either a network node, or from another device, WTRU or UE.

An IoT device described herein may be configured by a reader. The reader may be a network node, a WTRU, or a UE (e.g., intermediate node 415 in FIG. 4). In the case of a WTRU or UE, the WTUR or UE may derive the IoT device configuration itself, or receive the IoT device configuration from the network. In this case, the IoT device configuration may be relayed from the network to the IoT device by the WTRU or UE. On the other hand, a WTUR or UE configuration (e.g., in the case that the WTRU or UE is the intermediate node 415 in FIG. 4) may be received from a network node (e.g., the gNB or BS 405 in FIG. 4).

The term resource (when referring to the IoT interface) may refer to at least any of a time/frequency resource, a frequency resource which may be available at different times, and a time resource. For example, the time resource may be limited to one or more frequencies or frequency ranges. The time resource may start from the transmission of a reader message, and last either a maximum period of time, or until the next transmission by the reader, possibly of a specific message.

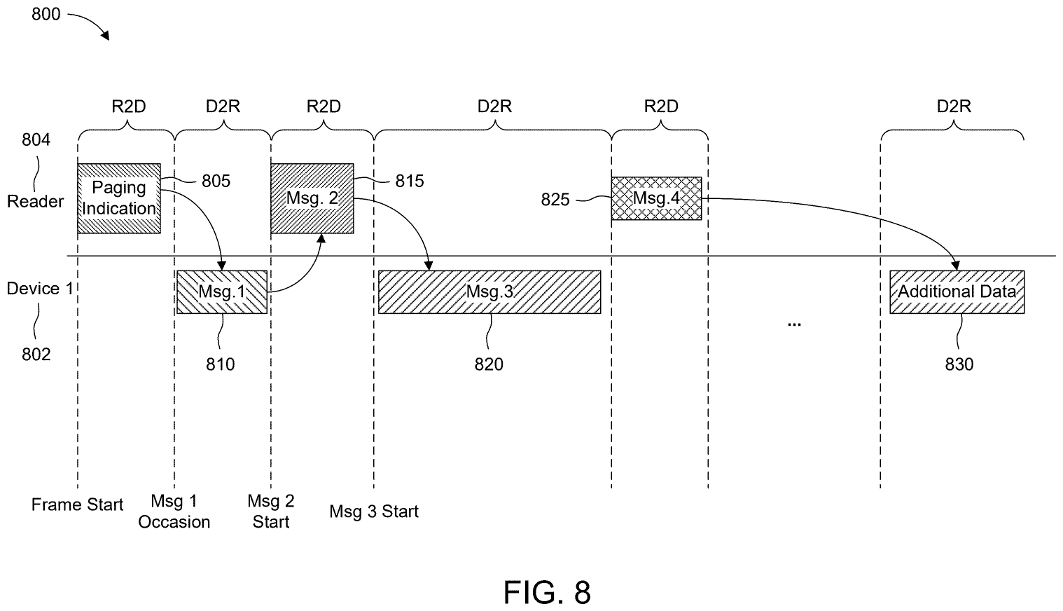

FIG. 8 illustrates an example procedure 800 for provisioning one or more resources, which may be used in combination with any of other embodiments described herein. As illustrated in FIG. 8, the procedure 800 may include provisioning msg1 resources. Specifically, a single msg1 occasion may be provisioned within a paging frame and/or multiple msg1 occasions may be provisioned within a paging frame. In one example, a reader 804 may initiate an inventory procedure with a paging indication 805 (e.g., an R2D paging indication) indicating the start of a frame. The paging indication 805 may include one or more resources such as the time/frequency/code resource(s) of at least one occasions for a device1 802 (e.g., an IoT device) that is to transmit msg1 810. The paging indication 805 may include one or more identifications (IDs). For example, the paging indication 805 may include a set of random IDs that may be selected by the device1 802 (e.g., an IoT device) for device transmission in the msg1 810. The paging indication 805 may include additional information needed for the transmission of msg1 810. The additional information may include, but is not limited to: transmission timing information (e.g., chip timing, clock/frequency reference, etc.), modulation configuration (e.g., PSK, OOK, etc.), line coding configuration (e.g., Manchester, pulse-interval encoding, etc.), repetition configuration (e.g., number of repetitions, repetitions identifiers, etc.), and transmit power configuration. The additional information needed for the transmission of msg1 810 in each of the msg1 occasions may also include whether information on IoT device availability based on stored/harvested power level is expected. For example, a device (e.g., the device1 802) may include, in msg1 (e.g., msg1 810), transmission information related to its remaining power such as an expected time before the device becomes unavailable, or the like.

The paging indication 805 may include additional information needed for the device 802 to receive msg2 815 in response to the msg1 810. The additional information may include, but are not limited to: timing information for when to expect the msg2 815 (e.g., timing window start/stop), frequency information (e.g., frequency location of msg2 815), modulation configuration (e.g., PSK, OOK, etc.), line coding configuration (e.g., Manchester, pulse-interval encoding, etc.), and repetition configuration (e.g., number of repetitions, repetitions identifiers etc.).

In another example, the reader 804 may initiate an inventory procedure with the paging indication 805 (e.g., an R2D paging indication) indicating the start of a frame that includes multiple occasions for the msg1 810. The paging indication 805 may include one or more resources such as the time/frequency/code resource(s) for multiple occasions for the device 802 (e.g., an IoT device) to transmit the msg1 810. The paging indication 805 may include one or more identifications (IDs). For example, the paging indication 805 may include a set of random IDs that may be selected by the device 802 (e.g., an IoT device) for device transmission in all or a subset of the msg1 transmission occasions.

The paging indication may include additional information needed for the transmission of msg1 810 in each of the msg1 occasions. The additional information may include, but are not limited to: transmission timing information (e.g., chip timing, clock/frequency reference, etc.), modulation configuration (e.g., PSK, OOK, etc.), (line coding configuration (e.g., Manchester, pulse-interval encoding, etc.), (repetition configuration (e.g., number of repetitions, repetitions identifiers, etc.), and transmit power configuration. The additional information needed for the transmission of msg1 810 in each of the msg1 occasions may also include whether information on IoT device availability based on stored/harvested power level is expected. For example, a device (e.g., the device1 802) may include, in msg1 (e.g., msg1 810), transmission information related to its remaining power such as an expected time before the device becomes unavailable, or the like. The additional information needed for the transmission of msg1 810 in each of the msg1 occasions may also include availability of msg1 occasion, for example, based on device capability with regard to timing, power availability, transmit power, or the like. For example, the reader 805 may provision multiple msg1 occasions in different time resources. Time resources shortly following the paging indication 805 may be available for all devices, while time resources much later than the paging indication 805 may be limited to devices with a certain clock frequency reliability.

The paging indication 805 may include additional information needed for the device 802 to receive a response, for example, msg2 815 in response to the msg1 810. The additional information may include, but is not limited to: timing information for when to expect msg2 815 (e.g., timing window start/stop), frequency information (e.g., frequency location of msg2), modulation configuration (e.g., PSK, OOK, etc.), line coding configuration (e.g., Manchester, pulse-interval encoding, etc.), and repetition configuration (e.g., number of repetitions, repetitions identifiers, etc.). The additional information needed for the device 802 to receive a response may also include information of association of each msg2 transmission with each corresponding msg1 occasion (e.g., msg2 transmission X corresponds to msg1 transmission in msg1 occasion Y, etc.) For example, all devices may monitor the same resources for a msg2 response to their msg1 transmission regardless of the msg1 occasion selected. Alternatively or additionally, devices may monitor one or more specific resources/subset of resources associated with the selected occasion in which they transmitted msg1.

One or more resources may be scheduled or structured for msg3 transmission as described herein. In one example, the reader 804 may transmit the msg2 815 in response to the msg1 810 received from the device1 802 (e.g., an A-IoT device) in a msg1 occasion. The reader 804 may initiate a command to the device1 802. The command may be included in any messages such as the paging indication and the msg2. For example, the command may be a “read” command wherein the device1 802 is expected to read the data from a memory location and the response to the command may be the data the device reads from the memory location. In another example, the command may be a “write” command and the response may be an acknowledgement.

The command may have associated information (e.g., information/data associated with the command) or associated control information to be sent/configured/indicated by the reader 804. For example, a “read” command may be associated with the information of an address of a memory location the device1 802 is expected to read. For example, a “write” command may be associated with the information of an address for a memory location and the data to write to that memory location. The command and the associated information (or associated control information) may be sent to the device1 802, for example, in the msg2 815.

The reader 804 may determine one or more resources for the command. For example, the one or more resources to be determined may be required for the scheduled read/write operation. The one or more resources may be determined based at least on one or more of: the quality of the D2R channel measured by the reader, the quality of the R2D channel reported by the device1 802, an estimate of the response data transmission size based on historical/statistical analysis of similar responses, device capabilities previously indicated to the reader/network (e.g., timing error, quantization error, etc.), resource availability, and an estimate and/or report of available device energy from the device1 802.

The reader 804 may include the information associated with the command as well as information associated with the proper generation of the device response in msg2 815. Msg2 transmission may include information related to provisioning of msg3 transmission by the device1 (e.g., an IoT device). The information related to provisioning of msg3 transmission may include, but is not limited to: the random identifier selected by the device1 802 and included in the msg1 transmission, a device identifier for the association of the device with physical channels (e.g., msg3 820 that may be scheduled by the reader 804 for the device1 802), and information for the proper generation of msg3 820. The information for the proper generation of msg3 820 may include but is not limited to: transmission timing information (e.g., chip timing, clock/frequency reference, etc.), one or more time/frequency/code resources for at least one msg3 transmission, modulation configuration (e.g., PSK, OOK, etc. for at least one msg3 transmission), line coding configuration (e.g., Manchester, pulse-interval encoding, etc. for at least one msg3 transmission), repetition configuration (e.g., number of repetitions, repetitions identifiers etc. for at least one msg3 transmission), and transmit power configuration for at least one msg3 transmission.

The reader 804 may determine that an additional transmission or resource is necessary due to, for example, inability to complete the command to the device1 802 (e.g., an IoT device) within a time period (e.g., the duration of the current paging frame). This determination may be made based on one or more of: a message from the device1 802, energy level of the device1 802, expected time needed to fulfill the command, the size of the data associated with the command, the size of response, type of the command, a parameter associated with the inventory, a higher priority operation, device ID, device type, and/or the like (other possibilities are not precluded herein).

As described above, the reader 804 may determine that an additional transmission or resource is necessary based on the message from the device1 802. For example, the device1 802 (e.g., as a response to a command by the reader 804) may send a message to the reader 804 indicating that more time is needed by the device1 802 to process the command. The message may indicate to the reader at least one of the following: an indication of the amount of (e.g., approximate or expected) time needed, an indication that the device is still processing the command, an indication that the device cannot complete processing a command in a specific time duration, an indication that the device requests resources at a future time (e.g., slot, paging frame, or the like), and the like.

The reader 804 may determine that an additional transmission or resource is necessary based on energy level of the device1 802. For example, the device1 802 may have reported energy level status to the reader 804 and the reader 804 may determine that the device1 802 may not have sufficient energy to process a command in a time interval or a time period. The time interval or the time period may be determined by the reader 804 based on the energy level information provided from the device. For example, the device1 802 may include, in msg1 810, transmission information related to its remaining power such as an expected time before the device1 802 becomes unavailable, or the like.

The reader 804 may determine that an additional transmission or resource is necessary based on expected time needed to fulfill the command. For example, the reader 804 may determine that the time needed to fulfill the command is above a threshold. The threshold may be the time interval or time period. The expected time may comprise one or more of: time needed for sending the command and the associated data, time needed for receiving the response from the device1 802, time needed by the devcie1 802 to process the command, or time needed for transmission being longer than the maximum duration the device1 802 can maintain the link quality.

As described above, the expected time may be the time needed for sending the command and the associated data. For example, the expected time may be the time needed for transmission of a write command where the data is to be written. In one example, if the data is 1000 bits and the data rate of the R2D channel or R2D transmission is 1 kbits/second, at least 1 second may be needed to send the data to the device1 802.

The expected time may be the time needed for receiving the response from the device1 802. For example, the response to a read command may be the data that the device1 802 has read from a memory location and the time needed for transmission of the response may be above a threshold. In one example, if the data is 1000 bits and the data rate of the D2R channel or transmission is 1 kbits/second, at least 1 second may be needed just to send the data to the reader 804. In one example, the device1 802 may indicate to the reader 804 the amount of data that the device1 802 may have or may expect to have (e.g., in a buffer), the indication may be performed as a response to a command from the reader 804, and/or the like. The reader 804, based on the received indication, may determine to allocate resources to the device1 804 (e.g., for the transmission of the indicated data).

The expected time may be the time needed by the device1 802 to process the command. For example, the time needed by the device1 802 to process the command is the time needed to read from a memory location, to write to a memory location, or the like.

The expected time may be the time needed for transmission that may be longer than the maximum duration that the device1 802 can maintain the link quality. For example, the timing of data transmission from the device may become out of sync with the timing of the data reception from the reader. For example, the clock stability for a device (e.g., an IoT device, or the device1 802) in not high. The changing frequency may result in an accumulating time and phase error between the symbol being transmitted by the reader/device and the symbol being read by its counterpart.

This error may become worse over time, and therefore re-synchronizing may be necessary before all the relevant data can be transmitted.

The reader 804 may determine that an additional transmission or resource is necessary based on the size of the data associated with the command. For example, the size of the data associated with the command may be the size of the data to write and/or the size of the data to indicate the memory location. For example, the reader 804 may determine that the device1 802 may not fulfill the command in a time interval or a time period if the size is above a threshold. The threshold may be pre-determined, pre-configured or configured. The threshold may be pre-determined, pre-configured, configured, or determined based on one or more of: a message from the device1 802, energy level of the device1 802, expected time needed to fulfill the command, the size of the data associated with the command, the size of response, type of the command, a parameter associated with the inventory, a higher priority operation, device ID, device type, and/or the like (other possibilities are not precluded herein).

The reader 804 may determine that an additional transmission or resource is necessary based on the size of the response. For example, the size of the response may be the size of the data that the device1 802 reads and is expected to send back to the reader 804. For example, the reader 804 may determine that the device1 802 may not fulfill the command in a time interval or a time period if the size is above a threshold.

The reader 804 may determine that an additional transmission or resource is necessary based on the type of a command (e.g., configured by network or defined). For example, for some commands (e.g., read, write, or the like), the reader 804 may determine that the device1 802 may not fulfill the command in a time interval or in a time period.

The reader 804 may determine that an additional transmission or resource is necessary based on a parameter associated with the inventory. The parameter may be one or more of an inventory ID, a session ID, a priority value, a QoS value/parameter, and/or the like. For example, for a high-priority inventory round (e.g., high priority may mean that the inventory should be completed in a specific time duration), the reader 804 may determine that the device1 802 may not fulfill the command in a time interval or a time period.

The reader 804 may determine that an additional transmission or resource is necessary based on priority. For example, a higher priority operation may pre-empt the conclusion of a read/write command. For example, the reader 804 may need to interrupt a device read/write operation in order to complete a Uu procedure for maintaining network connectivity (e.g., handover, RRM measurement, or the like). The reader 804 may determine that an additional transmission or resource is necessary based on a device ID and or device type. The device ID and/or the device type may be associated with an IoT device (e.g., device1 802).

One or more additional resources may be provisioned to a device (e.g., the device1 802) to compete a command. For example, if the reader 804 has determined the device1 802 cannot complete the command within the available resources scheduled for the msg3 820, the reader 804 may determine that additional resources are required at one or more occasions separated from the msg3 transmission. These resources may be allocated for the reader 804, for example, to complete an additional write operation, to transmit data to the device1 802 to be updated in memory, or to complete an additional read operation in which the device1 802 continues transmitting additional data to the reader 804.

The determination of the one or more additional resources required may be made by the reader 804 based on one or more of: the quality of the D2R channel or transmission measured by the reader 804, the quality of the R2D channel or transmission reported by the device1 802, an estimate of the response data transmission size based on historical/statistical analysis of similar responses, device capabilities previously indicated to the reader/network (e.g., timing error, quantization error, or the like), resource availability, and/or an estimate and/or report of available device energy from the device1 802.

The one or more additional resources or scheduled resource for additional data transmission may be indicated to the device1 802 in either msg2 815 along with the indication scheduling msg3 transmission, or in a separate transmission (e.g., msg4 825) after msg3 transmission/reception has concluded.

One or more resources for additional transmission/reception may be explicitly indicated. Information related to provisioning the one or more resources for additional transmission/reception or information for the proper generation of additional data transmission/reception may include, but is not limited to: transmission timing information (e.g., chip timing, clock/frequency reference, or the like), one or more time/frequency/code resources for at least one additional transmission, modulation configuration (e.g., PSK, OOK, or the like) for at least one additional transmission, line coding configuration (e.g., Manchester, pulse-interval encoding, or the like) for at least one additional transmission, repetition configuration (e.g., number of repetitions, repetitions identifiers, or the like) for at least one additional transmission, and/or transmit power configuration for at least one additional transmission.

The explicit indication of one or more resources for additional transmission/reception may also include information related to how a device (e.g., the device1 802) may indicate acknowledgement of this scheduling grant for additional information and/or device availability for additional information transmission based on available power. The information for generating availability indication may include, but is not limited to: transmission timing information (e.g., chip timing, clock/frequency reference, or the like), one or more time/frequency/code resources for at least one additional transmission, modulation configuration (e.g., PSK, OOK, or the like) for at least one additional transmission, line coding configuration (e.g. Manchester, pulse-interval encoding, or the like) for at least one additional transmission, repetition configuration (e.g., number of repetitions, repetitions identifiers, or the like) for at least one additional transmission, and transmit power configuration for at least one additional transmission. Alternatively or additionally, information for this indication may be included as an additional field within msg3 transmission (e.g., msg3 820).

It is assumed in FIG. 8 that the indication for additional data is provided in an indication transmitted at the conclusion of msg3 reception.

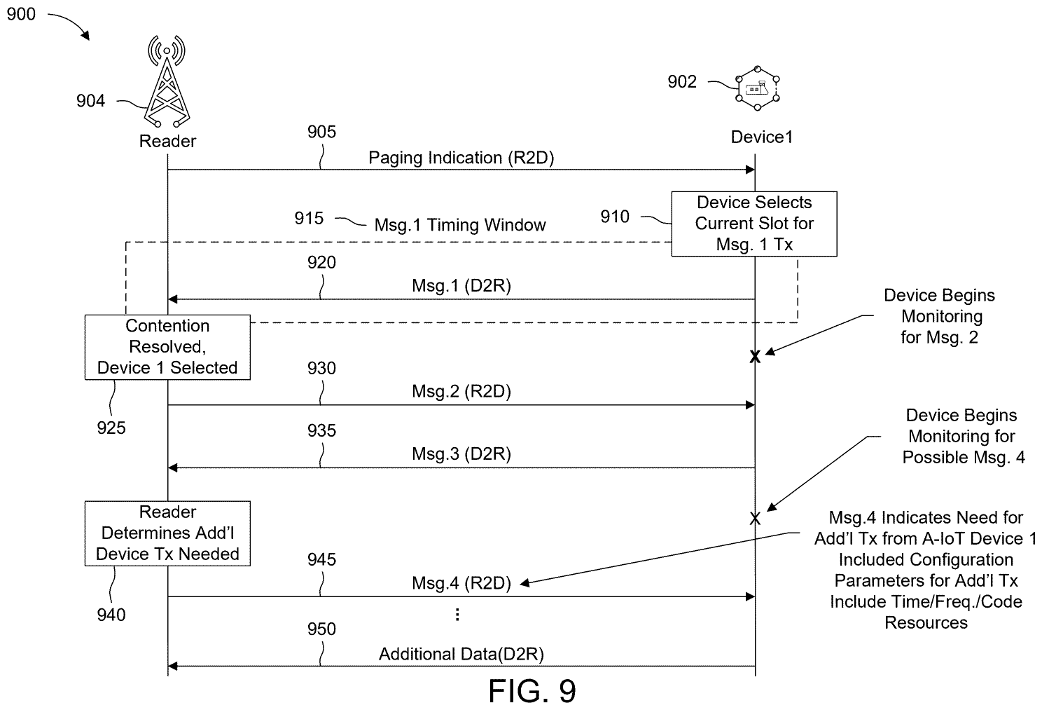

FIG. 9 illustrates an example signal flow 900, which may be used in combination with any of other embodiments described herein. As illustrated in FIG. 9, a reader 904 may send a paging indication to a device1 902 at 905. The paging indication may be unicast, multicast, or broadcast. For example, the reader 904 may initiate an inventory procedure (e.g., the signal flow 900) with the paging indication providing the timing reference for the frame in which the inventory procedure will proceed. The paging indication may include one or more time/frequency/code resources of at least one occasions (e.g., one or more slots in a slotted aloha access method) for the device1 902 to transmit msg1. The paging indication may include a set of random IDs. The paging indication may include additional information/data as descried in FIG. 8. At 910, the device1 902 may select an occasion/slot (e.g., a current occasion/slot) for msg1 transmission. In the paging indication or paging frame, the device1 902 may opt to attempt a transmission by transmitting msg1 in a random-access resource that has been configured by the paging indicator. At 920, the device1 902 may send a msg1 to the reader 904. For example, the device1 902 may select a random ID from the set of random IDs and send the msg1 to the reader 904. The devcie1 902 may send the msg1 based on the one or more time/frequency/code resources of at least one occasions/slots for the device1 902. For example, the device1 902 may randomly select one of the occasion/slot and send the msg1 based on the selected occasion/slot to the reader 904. The msg1 may be transmitted to the reader 904 during the timing window associated with the msg1 at 915.

The reader 904 may select the device1 at 925 based on reception of the msg1 and send a msg2 to the device1 at 930. The msg2 transmission from the reader 904 may provide the device1 902 with information for how to transmit msg3. For example, the msg2 may include information related to provisioning of msg3 transmission. The information may include one or more time/frequency/code resources for at least one msg3 transmission. The msg2 may include or indicate a command to be performed by the device1 902 and information/data associated with the command. For example, the command may be a read command where the devcie1 902 is expected to read data from its memory location. The response to the read command may be the data read by the device1 902 from the memory location. The command may be a write command where the device1 902 is expected to write data on a memory location. The response to the write command may be an acknowledge message. The msg2 may further include data/information as described in FIG. 8.

The device1 902 may send a msg3 at 935. The msg3 may be a response to the msg2. For example, the msg3 may include data in response to the read command in the msg2. In another example, the msg3 may be an acknowledgement to the write command in the msg2. After receiving the msg3, the reader 904 may determine that more information may be needed from the device1 902 at 940. For example, the additional information may be related to the device1 902, but not necessary for the completion of the inventory procedure. The reader 904 may also determine that the additional information needed may not be transmitted within the paging frame. This may be due to the power or timing constraints on the device1 902, or possible requirements to complete the remainder of the inventory procedure within a specified time. As described in FIG. 8, the reader 904 may determine that an additional transmission or resource is needed due to the inability to complete the command sent to the device1 902 within a time period. The reader 904 may determine that the additional transmission or resource is needed based on one or more of: a message from the device1 902, energy level of the device1 902, expected time needed to fulfill the command, the size of the data associated with the command, the size of response, type of the command, a parameter associated with the inventory, a higher priority operation, device ID, device type, and/or the like. The message from device1 902 may be an indication provided from the device1, for example, in the msg3. The reader 904 may determine, based on the indication (e.g., msg3) provided from the devcie1 902 that additional transmission or resource is needed.

The reader 904 may then transmit a msg4 to the device1 902 at 945. The msg4 may indicate a need for additional transmission from the device1 902. The msg4 may indicate the necessary configuration for the transmission of the additional information or resource the additional transmission from the device1 902. The necessary configuration may comprise one or more time/frequency/code resources. For example, the device1 902 may have been provided the monitoring configuration for the msg4 from either the paging indicator 905 at the start of the paging indication or paging frame, or the msg2 transmission. Alternatively or additionally, monitoring for the msg4 may be specified as a mandatory part of the inventory procedure. For example, monitoring for the msg4 may occur (or may need to occur) in a time window configured/indicated/specified after the completion of msg3. The msg4 may also include the time/frequency/code resources for transmission for additional data as well as the relevant configuration parameters for coding and modulation of the data. In the specified resources for transmission of additional data, the device1 902 may then transmit the required data as configured at 950.

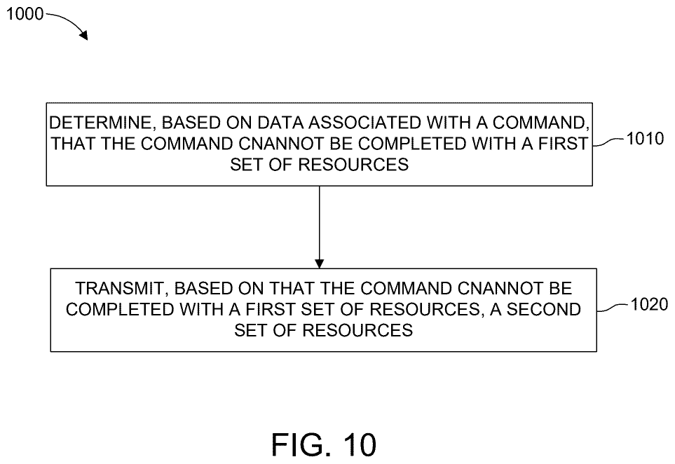

FIG. 10 illustrates an example procedure 1000 for the determination of additional resources, which may be used in combination with any of other embodiments described herein. A WTRU (e.g., reader WTRU) may be configured to transmit a message to a set of devices. The WTRU may refer to a reader when it queries a device, either directly, or via an intermediate node (e.g., the intermediate node 415 in FIG. 4) or an assisting node (e.g., the assisting node 515a in FIG. 5A). The WTRU, UE, WTRU reader, UE reader, a network node, an intermediate node, and an assisting node may be used interchangeably when they refer to the entity that queries the device directly or indirectly. The WTRU may be configured with a time period associated with a device from the set of devices. For example, the time period may be associated with a transmission of messages such as msg2, msg3, and msg4. For example, the time period may be the duration between the start of msg3 and the end of msg3. The time period may be a preconfigured duration associated with a transmission of messages such as msg2, msg3, and msg4. The time period may be a threshold configured or preconfigured by the WTRU or network. The time period may be an expected time that a reader or a device processes a command. For example, the time period may be determined based on one or more of data size and/or a transmission/data rate.

At 1010, the WTRU may determine that at least one command associated with the message cannot be completed by a device of the set of devices with a first set of resources. For example, the WTRU may determine, based on data associated with the at least one command, that at least one command associated with the message cannot be completed by the device with a first set of resources. For example, the WTRU may determine that the at least one command to the device cannot be completed with a first set of time/frequency resources based on data associated with the at least one command. The at least one command may be performed by the device of the set of devices. The device may be an IoT device, AIoT device, IoT UE, AIoT UE, IoT WTRU, AIoT WTRU, and tag that is being inventoried/queried by a reader. The device may be WTRU or UE when the WTRU or UE is being inventoried/queried by a reader. The first set of resources may comprise one or more time/frequency/code resources.

The at least one command may comprise at least one of a write command or a read command. The data may be written to the device based on the write command. For example, the WTRU may determine, based on the data to be written to the device not completed within the time period, that the at least one command associated with the message cannot be completed by the device with a first set of resources. For example, when the data associated with the command (e.g., data to be written to the device due to a write command) cannot be transmitted to the device within the configured time period, the WTRU may determine that the device cannot be served with a first set of time/frequency resources. In one example, the WTRU may determine, based on a size of the data associated with the write command, that the write command cannot be completed by the device within a time period. The WTRU may determine, on a condition that the write command cannot be completed by the device within the time period, that the at least one command cannot be completed by the device with the first set of resources.

The data may be read from the device based on the read command. For example, the WTRU may determine, based on the data to be read from the device not transmitted within the time period, that the at least one command cannot be completed by the device with the first set of resources. In one example, the WTRU may determine, based on a transmission rate of the data associated with the read command, that the read command cannot be completed by the device within a time period. The WTRU may determine, on a condition that the read command cannot be completed by the device within the time period, that the at least one command cannot be completed by the device with the first set of resources.

The at least one command may further comprise general IoT commands, AIoT commands, and RFID commands. Examples of the general IoT commands may include, but are not limited to, device configuration commands, and connectivity commands. The device configuration commands may include a “configured device” command, a “firmware update” command, a “factory rest” command. The connectivity commands may include a “connect to network” command, a “ping device” command. Examples of the AIoT commands may include, but are not limited to, data commands, device control commands, communication and protocol commands, and AI specific commands. The data commands may include a “data ingestion” command, a “data processing” command, and a “data retrieval” command.

The data control commands may include a “device discovery” command, a “command and control” command, and an “AI model update” command. The communication and protocol commands may include a “MQTT publish/subscribe” command, and “HTTP/REST API calls” command. The AI specific commands may include a “inferencing” command, and a “train AI model” command. The RFID commands may include, but are not limited to, read commands, write commands, and tag access commands. The read commands may include a “read tag data” command, an “inventory” command, and a “read memory bank” command. The write commands may include a “write tag data” command, a “lock/unlock tag” command, and a “kill” command. The tag access commands may include an “authenticate” command, and a “read access permissions” command.

In one example, the WTRU may be configured with a first time period associated with the at least one command. The first time period may be a preconfigured duration associated with a transmission of messages such msg2, msg3, and msg4. The time period may be a threshold configured or preconfigured by the WTRU or network. The time period may be an expected time that a reader or a device processes a command. For example, the time period may be determined based on one or more of data size and/or a transmission/data rate. The WTRU may determine, based on a second time period that the device expects to complete the at least one command being greater than the first time period, that the at least one command cannot be completed by the device within the first time period with the first set of resources provided. For example, the second time period may be time duration that the device needs to fulfill the command. The second time period may comprise at least one of time expected to send the at least one command and data associated with the at least one command, time expected to receive a response from the device, or time expected to process the at least one command by the device. For example, the WTRU (e.g., reader) may send a read command with data comprising large data payload (e.g., 1000 bits) to the device. The device may receive the read command with the data comprising the large data payload, and read its memory location to process the read command. The device may prepare and send information to the WTRU based on the memory the device read. These three components (e.g., sending the read command, processing the read command, and sending information back) may form the second time period or the time duration that the device needs to fulfill the command. The WTRU may determine, based on the second time period being greater/larger than the first time period/configured time period, that the at least one command cannot be completed by the device with the first set of resources.

At 1020, the WTRU may transmit, to the device, a second set of resources. For example, the WTRU may transmit the second set of resources on a condition that the at least one command cannot be completed by the device with the first set of resources. For example, the WTRU may transmit, to the device, a second set of time/frequency resource (or a second set of time/frequency resource allocation), based on the determination that the device cannot be served with the first set of time/frequency resources. For example, the second set of time/frequency resource may occur after an ongoing inventory procedure ends. Alternatively or additionally, the WTRU may transmit, to the device, another message comprising a command. The command may indicate the device to monitor a paging message that includes at least one of a device ID or the second set of resource. The device ID may be associated with the device. For example, the WTRU may send a command to the device to monitor a paging indication/message that includes at least the device ID and a second time/frequency resource (or a second time/frequency resource allocation) for the device. The WTRU may monitor a response from the device. The response may indicate that the device is available or expects to be available to use the second set of resources.

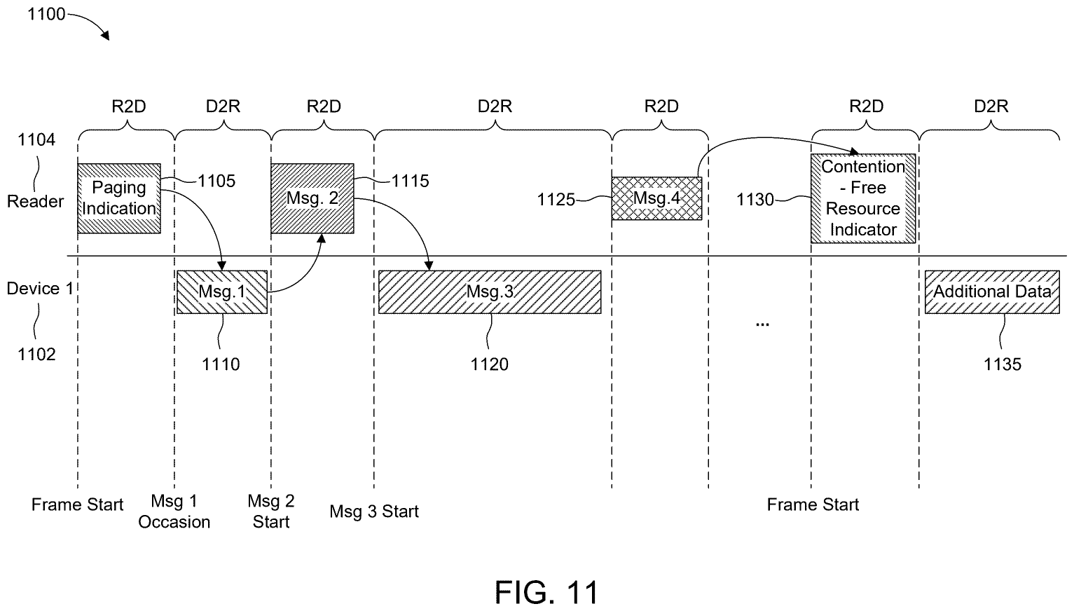

FIG. 11 illustrates an example procedure 1100 for indication of resources for additional transmission/reception by reference to a contention-free resource indication, which may be used in combination with any of other embodiments described herein. The procedures related to a paging indication 1105, msg1 1110, msg2 1115, msg3 1120, and msg4 1125 may be the same or similar to those procedures described in FIG. 8 and not described herein for brevity. As illustrated in FIG. 11, the msg4 1125 by a reader 1104 may indicate a contention-free resource 1130, which is delimited by the reader 1104 for a device1 1102 to transmit/receive additional data 1135 or additional information. In one example, the device1 1102 may be provided an indication for a scheduled R2D transmission or granted a D2R transmission in a contention-free resource. The start/end of one or more time/frequency/code resources (e.g., a slot or frame) may be indicated by an indication transmitted from the reader 1104, for example, in paging indication and/or QueryRep messages. The indication may include a bit field. The bit filed may indicate if this slot is allocated for random access or contention-free access. If the resource is indicated for random access, the device1 1102 may proceed according to regular random-access procedure. If the resource is indicated as contention-free, the resource may be reserved by the reader 1104 only for a device based on special indication.

The device1 1102 may be provided a special indication. The special indication may include, but is not limited to: a resource identifier for uniquely identifying the contention-free resource, a device identifier for uniquely identifying the device1 1102 which may access the contention-free resource, one or more time/frequency/code resources for at least one additional transmission/reception, modulation configuration (e.g., PSK, OOK, or the like) for at least one additional transmission/reception, line coding configuration (e.g., Manchester, pulse-interval encoding, or the like) for at least one additional transmission/reception, repetition configuration (e.g., number of repetitions, repetitions identifiers, or the like) for at least one additional transmission/reception, and transmit power configuration for at least one additional transmission/reception.

If the device1 1102 receives this indication, it may transmit or receive data/information in the resources indicated by the schedule indication based on beginning the random-access procedure. In the procedure 1110, it may be assumed that the special indication for additional data may be provided in an indication transmitted at the conclusion of msg3 reception.

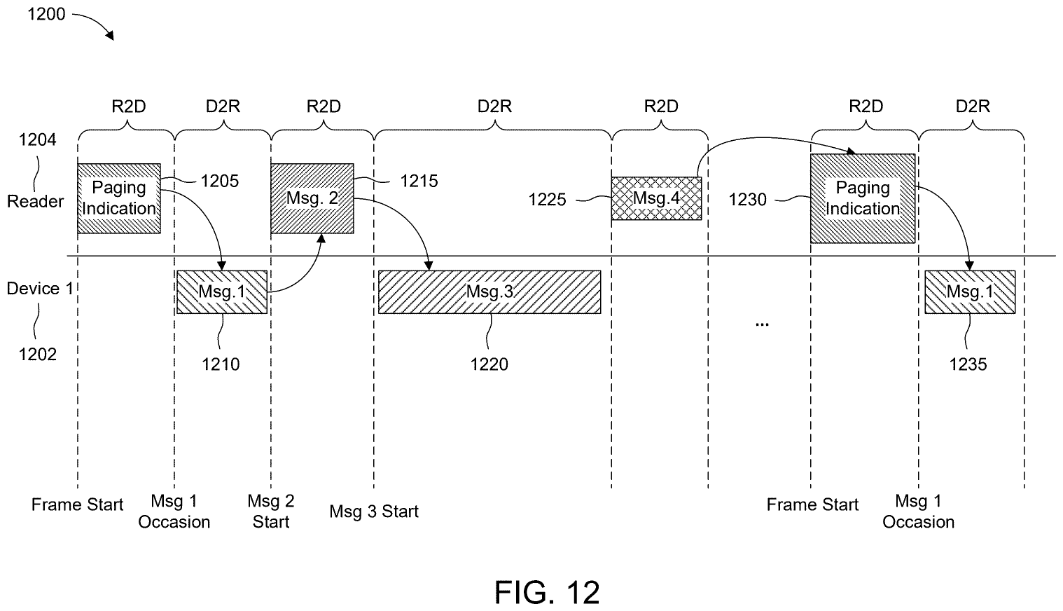

FIG. 12 illustrates an example procedure 1200 for indication of resources for additional transmission/reception based on prioritized random-access, which may be used in combination with any of other embodiments described herein. The procedures related to a paging indication 1205, msg1 1210, msg2 1215, msg3 1220, and msg4 1225 may be the same or similar to those procedures described in FIG. 8 and not described herein for brevity. As illustrated in FIG. 12, the msg4 1225 by a reader 1204 may indicate a paging indication 1230 with high-priority random access for a device1 1202 to transmit/receive additional information. In one example, the device1 1202 may be provided an indication for a scheduled R2D transmission or granted a D2R transmission in another paging resource with higher priority. The start/end of one or more time/frequency/code resources (e.g., a slot or frame) may be indicated by an indication transmitted from the reader 1204, for example, in a new paging indication. The device1 1202 may be provided a priority indication. The priority indication may include, but are not limited to: an identifier for the paging occasion in which the device1 1202 is expected to transmit msg1 1235, a high priority msg1 random access identifier, a device identifier for uniquely identifying the device1 1202 which may access the priority paging resource.

After receiving the priority indication from the reader 1204, the device1 1202 may wait until the paging occasion indicated in the priority indication. The device1 1202 may transmit the msg1 1235 using the priority random access identifier indicated in the priority indication in the available msg1 occasion. The reader 1204 may prioritize a msg1 transmission made with a priority identifier over a msg1 transmission made without a priority identifier, when scheduling msg3 transmission (e.g., the msg3 1220). in the procedure 1200, it may be assumed that the special indication for additional data may be provided in an indication transmitted at the conclusion of msg3 reception.

Embodiments for the determination of minimum and maximum time between msg1 transmission and msg2 response are described herein. After transmission of msg1, a device may expect reception of msg2 within a time window. If the device does not receive msg2 confirming reception of msg1 within the time window, the device may assume that transmission of msg1 was unsuccessful and perform actions accordingly (e.g., select another resource for msg1 or wait for a subsequent paging indicator). The condition may apply to the reception of a complete msg2. Alternatively or additionally, the device may make the determination after completing reception of a reader transmission starting at any time before the end of the time window.

The time window may be defined by a minimum time and maximum time T_{D2R_min} and T_{D2R_max} respectively, wherein the start and end of the time window correspond to t₀+T_{D2R_min} and t₀+T_{D2R_max} respectively and t₀ may correspond to a reference time. The reference time may be the start or the end of the msg1 transmission. In one example, the device may use pre-defined values for at least one of T_{D2R_min} and T_{D2R_max}.

In some examples, there may be more than one time occasion for the transmission of msg1 following reception of a paging indicator or of another reader transmission providing resources for msg1 (e.g., QueryRep). The number of time occasions may be indicated in the reader transmission. The device may determine the start and end of the window as a function of the number of time occasions Nₜₒₜ, the time occasion n it selected for the transmission of msg1, and the duration of a msg1 transmission T_{msg1}. More specifically, if time occasions are indexed as {0, 1, . . . , Nₜₒₜ−1} then the device may determine that the time window starts at t₀+(Nₜₒₜ−n−1)×T_{msg1}, and that the time window ends at t₀+(Nₜₒₜ−n−1)×T_{msg1}+Tᵣₑₛₚ. The value of Tᵣₑₛₚ may be interpreted as a maximum duration over which the reader is expected to provide msg2 transmissions for a set of devices. The device may use a pre-defined value for Tᵣₑₛₚ. Alternatively or additionally, the device may determine Tᵣₑₛₚ from a transmission by a reader. For example, the value may be explicitly indicated in the transmission. In another example, the value may be proportional to a number of time occasions and/or frequency occasions for msg1 transmission indicated in the reader transmission.

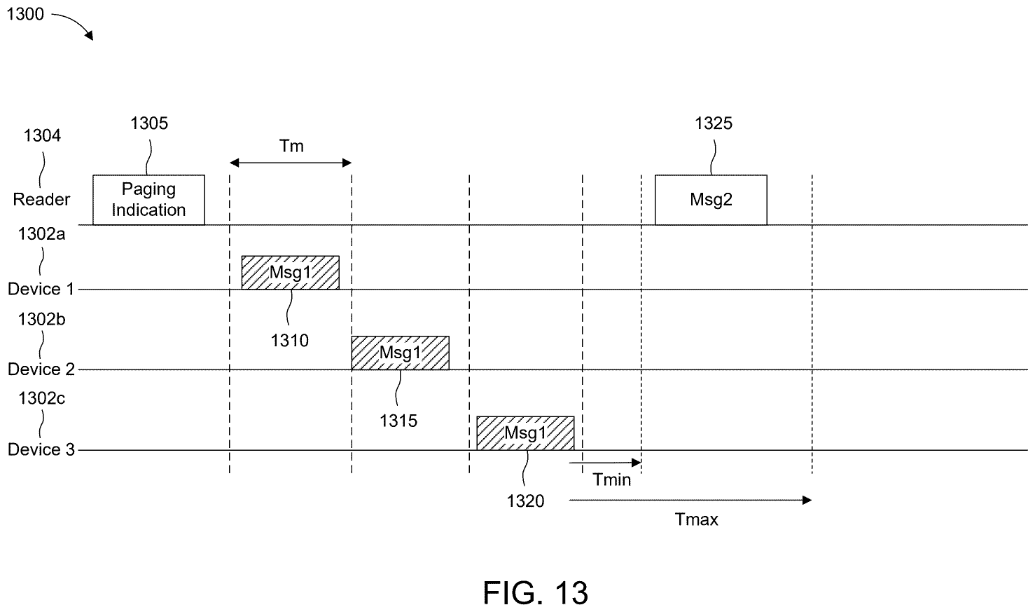

FIG. 13 illustrates an example of time windows 1300 between messages, which may be used in combination with any of other embodiments described herein. As illustrated in FIG. 13, a reader 1304 may send a paging indication (e.g., QueryRep) 1305 to devcies1-3 1302a-c. A device1 1302a may respond to the paging indication 1305 with a msg1 1310. The msg1 1310 may be transmitted during the first duration of Tₘ. A device1 1302b may respond to the paging indication 1305 with a msg1 1315. The msg1 1315 may be transmitted during the second duration of Tₘ. A device1 1302c may respond to the paging indication 1305 with a msg1 1320. The msg1 1320 may be transmitted during the third duration of Tₘ. In one example, a device (e.g., device1 1203a, device2 1302b, and/or device3 1302c) may determine that the time window to monitor msg2 1325 is between (Nₜₒₜ−n−1)×Tm+[t₀+T_{D2R_min}] and (Nₜₒₜ−n−1)×Tm+[t₀+T_{D2R_max}], where Tm may be the duration of a msg1 occasion and t₀ may be ignored if it denotes the end of the msg1 transmission, and n=0, 1, . . . Nₜₒₜ. For example, the device2 may use the second msg1 occasion (i.e., n=1), so the window that the device2 1302b may monitor may be between Tm+[t₀+T_{D2R_min}] and Tm+[t₀+T_{D2R_max}], wherein t₀ is the time msg1 transmission of the device2 1302b ends.

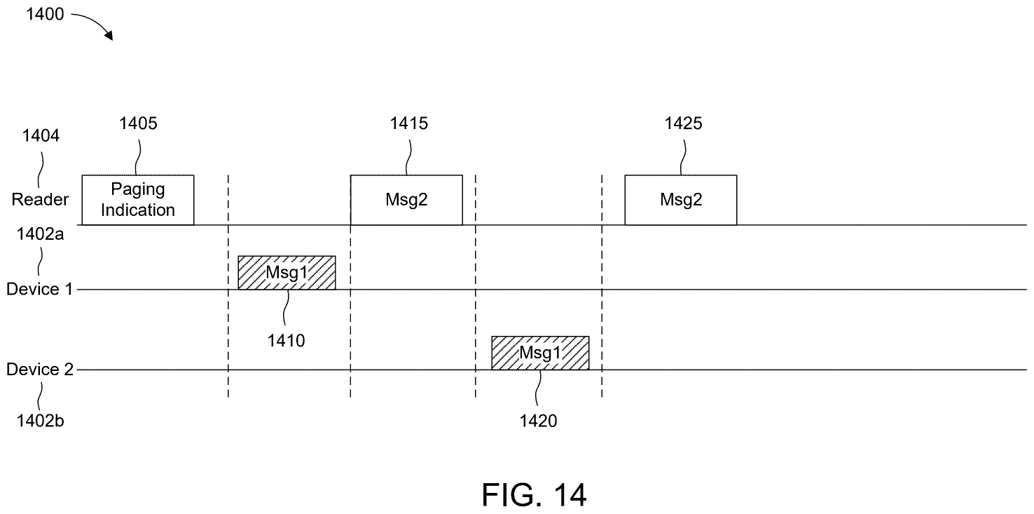

FIG. 14 illustrates an example of time windows 1400 between messages, which may be used in combination with any of other embodiments described herein. As illustrated in FIG. 14, the reader 1404 may send a msg2 1415, 1425 after every msg1 transmission. For example, the reader 1404 sends the msg2 1415 after it receives the msg1 1410 from the device1 1402a. The reader 1404 sends the msg2 1425 after it receives the msg1 1420 from the devcie2 1402b. The msg2 1415, 1420 may be determined by a device (e.g., device1 1402a, and/or device2 1402b) to indicate the index of the upcoming msg1 occasion. For example, the first msg1 occasion (e.g., msg1 1410) may be determined to follow a paging indication 1405, and the second msg1 occasion (e.g., msg1 1420) may be determined to follow the msg2 message 1415 sent in response to the msg1 transmission in the first occasion and so forth. In one example, the msg2 1415, 145 may comprise the msg1 occasion index.

In one example, more than one device may transmit msg1 in one msg1 occasion, for example using FDMA (e.g., each device may use a different frequency band to transmit msg1). The msg2 may comprise the response to the multiple msg1s received. In another example, msg1 may comprise multiple sub-messages. Each sub-message may include, but is not limited to, a subband/frequency identifier (e.g., an index), the part or all msg1 received in that subband/frequency (e.g., a 16-bit random number transmitted as msg1), and a CRC. In another example, msg1 may include a bitmap wherein the size of the bitmap may be equal to the number of available subbands/frequencies in that inventory round. A bit in the bitmap may indicate whether a msg1 was received in the corresponding subband/frequency or not. Msg2 may also comprise the received msg1s, and a CRC, wherein the order of the msg1s in msg2 may follow the order of the bits in the bitmap corresponding to successfully received msg1s.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU) configured to transmit a message comprising at least one command to a set of devices, the method comprising:
determining, based on data associated with the at least one command, that the at least one command cannot be completed by a device of the set of devices with a first set of resources, wherein the at least one command is to be performed by at least the device of the set of devices; and
transmitting, to the device, on a condition that the at least one command cannot be completed by the device with the first set of resources, a second set of resources to complete the at least one command.

2. The method of claim 1, wherein the at least one command comprises at least one of a write command or a read command.

3. The method of claim 2, wherein the data is to be written to the device based on the write command.

4. The method of claim 3, further comprising:
determining, based on a size of the data associated with the write command, that the write command cannot be completed by the device within a time period; and
determine, on a condition that the write command cannot be completed by the device within the time period, that the at least one command cannot be completed by the device with the first set of resources.

5. The method of claim 2, wherein the data is to be read from the device based on the read command.

6. The method of claim 5, further comprising:
determining, based on a transmission rate of the data associated with the read command, that the read command cannot be completed by the device within a time period; and
determining, on a condition that the read command cannot be completed by the device within the time period, that the at least one command cannot be completed by the device with the first set of resources.

7. The method of claim 1, further comprising:
determining, by the WTRU configured with a first time period associated with the at least one command, based on a second time period that the device expects to complete the at least one command being greater than the first time period, that that the at least one command cannot be completed by the device with the first set of resources.

8. The method of claim 7, wherein the second time period comprises at least one of time expected to send the at least one command and data associated with the at least one command, time expected to receive a response from the device, or time expected to process the at least one command by the device.

9. The method of claim 1, further comprising:
transmitting, to the device, another message comprising a command, wherein the command indicates the device to monitor a paging message that includes at least one of a device identification or the second set of resources.

10. The method of claim 1, further comprising:
monitoring a response from the device, wherein the response indicates that the device is available to use the second set of resources, wherein the WTRU is a reader and the device is an internet of things (IoT) device.

11. A wireless transmit/receive unit (WTRU) comprising:
a transceiver configured to transmit, to a set of devices, a message comprising at least one command, wherein the at least one command is to be performed by at least a device of the set of devices;
a processor configured to determine, based on data associated with the at least one command, that the at least one command cannot be completed by the device with a first set of resources; and
the transceiver further configured to transmit, to the device, on a condition that the at least one command cannot be completed by the device with the first set of resources, a second set of resources to complete the at least one command.

12. The WTRU of claim 11, wherein the at least one command comprises at least one of a write command or a read command.

13. The WTRU of claim 12, wherein the data is to be written to the device based on the write command.

14. The WTRU of claim 13, wherein the processor is further configured to:
determine, based on a size of the data associated with the write command, that the write command cannot be completed by the device within a time period; and
determine, on a condition that the write command cannot be completed by the device within the time period, that the at least one command cannot be completed by the device with the first set of resources.

15. The WTRU of claim 12, wherein the data is to be read from the device based on the read command.

16. The WTRU of claim 15, wherein the processor is further configured to:
determine, based on a transmission rate of the data associated with the read command, that the read command cannot be completed by the device within a time period; and
determine, on a condition that the read command cannot be completed by the device within the time period, that the at least one command cannot be completed by the device with the first set of resources.

17. The WTRU of claim 11, wherein the transceiver is further configured with a first time period associated with the at least one command; and wherein the processor is further configured to determine, based on a second time period that the device expects to complete the at least one command being greater than the first time period, that that the at least one command cannot be completed by the device with the first set of resources.

18. The WTRU of claim 17, wherein the second time period comprises at least one of time expected to send the at least one command and data associated with the at least one command, time expected to receive a response from the device, or time expected to process the at least one command by the device.

19. The WTRU of claim 11, wherein the transceiver is further configured to transmit, to the device, another message comprising a command, wherein the command indicates the device to monitor a paging message that includes at least one of a device identification or the second set of resources.

20. The WTRU of claim 1, wherein the transceiver is further configured to monitor a response from the device, wherein the response indicates that the device is available to use the second set of resources, and wherein the WTRU is a reader and the device is an internet of things (IoT) device.
